(19) United States
(12) Patent Application Publication
(10) Pub. No.: US 2018/0330683 A1
(43) Pub. Date: Nov. 15, 2018

(54) PIXEL DRIVING ELECTRODE, ARRAY SUBSTRATE THEREOF AND DISPLAY PANEL

(71) Applicant: SHENZHEN CHINA STAR OPTOELECTRONICS TECHNOLOGY CO., LTD., Shenzhan, Guangdong (CN)

(72) Inventor: Guangyang MO, Shenzhen, Guangdong (CN)

(73) Assignee: Shenzhen China Star Optoelectronics Technology Co., Ltd., Shenzhen, Guangdong (CN)

(21) Appl. No.: 15/541,704

(22) PCT Filed: May 27, 2017
(86) PCT No.: PCT/CN2017/086230

§ 371 Date: Jul. 5, 2017

(30) Foreign Application Priority Data
May 15, 2017 (CN) 201710339170.6

(51) Int. Cl. G09G 3/36

(52) U.S. Cl. CPC G09G 3/3648; G09G 2310/0251; G09G 2300/0876; G09G 2300/0809; G09G 2320/0252

(57) ABSTRACT

A pixel driving circuit includes a data line, a scanning line, a first pixel electrode, two or more first switches, a second pixel electrode, and two or more second switches. Iput terminals of the two or more first switches are connected to the data line. Output terminals of the two or more first switches are connected to the first pixel electrode. Control terminals of the two or more first switches are connected to the scanning line to accelerate charging of the first pixel electrode. Accordingly, the present disclosure improves display quality of the display image arised from insufficient charge of the first pixel electrode.

### BACKGROUND

### 1. Field of the Disclosure

The present disclosure relates to the field of display panels, and more particularly, to a pixel driving electrode, an array substrate with the pixel driving electrode, and a display panel.

### 2. Description of the Related Art

With the development of display technology, users' desire for high-definition and vivid display images shown on a liquid crystal display panel are growing. Especially, extremely high-definition images which adopts three-dimensional (3D) display technology are more and more popular to the audience. The frame rate is the number of frames of a display image driven per second. Provided that a switch, such as a thin film transistor (TFT), drives a liquid crystal display, the greater the frame rate is, the more images is displayed within a unit time and the more fluent image display is.

With a gradual increase in the frame rate, the switch charges a pixel electrode with a correspondingly decreasing time. As a result, the charging shortage of the pixel electrode occurs and further the display quality of the display image deteriorates, which limits the development and application of the liquid crystal display to a great extent.

A long-term study on the related art makes the applicant of the present disclosure gain some insight. In the related art, a pixel electrode is hardly well charged since the problem of display at high frame rates needs to be solved. Two technical plans are commonly adopted. One of the plans is to reduce Resistive-capacitive delay (RC delay) to increase the charging speed. Specifically, the thickness of a copper film layer and the width of a copper wire are broadened to reduce impedance and capacitance to lower RC delay. However, the adoption of this plan will cost a lot, and the size of a non-display area of the liquid crystal display panel or the thickness of the liquid crystal display panel may increase. As for the other plan, the method of enhancing the charging capacity of a pixel electrode within a scanning period at high frame rates can be done by using a switch with high carrier mobility material to charge the pixel electrode. Unfortunately, because it is somewhat difficult applying the high carrier electron mobility material on the technical field now, the application of the material is not very popular.

### SUMMARY

An object of the present disclosure is to propose a pixel driving electrode, an array substrate with the pixel driving electrode, and a display panel to accelerate the charging of the pixel driving electrode so as to improve the display quality of a display image.

According to one embodiment of the present disclosure, a pixel driving circuit includes a data line, a scanning line, a first pixel electrode, two or more first switches, a second pixel electrode, and two or more second switches. Input terminals of the two or more first switches are connected to the data line. Output terminals of the two or more first switches are connected to the first pixel electrode. Control terminals of the two or more first switches are connected to the scanning line to accelerate charging of the first pixel electrode. Control terminals of the two or more second switches are connected to the scanning line. An input terminal and an output terminal of one of the two or more second switches are connected to the data line and the second pixel electrode, respectively. An input terminal and an output terminal of the other one of the two or more second switches is connected to the output terminal of the one of the two or more second switches to lower pixel voltage of the second pixel electrode. A frequency of a scanning signal provided by the scanning line is greater than 120 hertz (Hz).

According to another embodiment of the present disclosure, an array substrate includes a plurality of pixel driving circuits arranged in an array. Each of the plurality of pixel driving circuits includes a data line, a scanning line, a first pixel electrode, and two or more first switches. Input terminals of the two or more first switches are connected to the data line. Output terminals of the two or more first switches are connected to the first pixel electrode. Control terminals of the two or more first switches are connected to the scanning line to accelerate charging of the first pixel electrode. The plurality of pixel driving circuits in the same column share the same data line, and the plurality of pixel driving circuits in the same row share the same scanning line. Or the plurality of pixel driving circuits in the same row share the same data line, and the plurality of pixel driving circuits in the same column share the same scanning line.

According to still another embodiment of the present disclosure, a display panel includes a first substrate, a second substrate, and a liquid crystal therebetween. The first substrate or the second substrate is the array substrate as provided above.

The present disclosure has benefits as follows. Compared with the related art, a pixel driving circuit provided by the present disclosure includes a data line, a scanning line, a first pixel electrode, and two or more first switches. An input terminal of each of the two or more first switches is connected to the data line. A control terminal of each of the two or more first switches is connected to the scanning line. An output terminal of each of the two or more first switches is connected to the same first pixel electrode. Because the two or more first switches charge the first pixel electrode, not only the charging of the first pixel electrode is accelerated but also the display quality of the display image is improved.

### BRIEF DESCRIPTION OF THE DRAWINGS

FIG. 1 illustrates a schematic diagram of a pixel driving circuit according one embodiment of the present disclosure.

FIG. 2 illustrates a schematic diagram of a pixel driving circuit according the embodiment of the present disclosure.

FIG. 3 illustrates a schematic diagram of the structure of a conductive channel of the TFT illustrated in FIG. 2 according the embodiment of the present disclosure.

FIG. 4A illustrates a schematic diagram of a pixel driving circuit.

FIG. 4B illustrates a schematic diagram of the structure of the pixel driving circuit illustrated in FIG. 4A according to another embodiment of the present disclosure.

FIG. 5 illustrates a schematic diagram of the structure of an array substrate according to another embodiment of the present disclosure

### DETAILED DESCRIPTION OF THE EMBODIMENTS

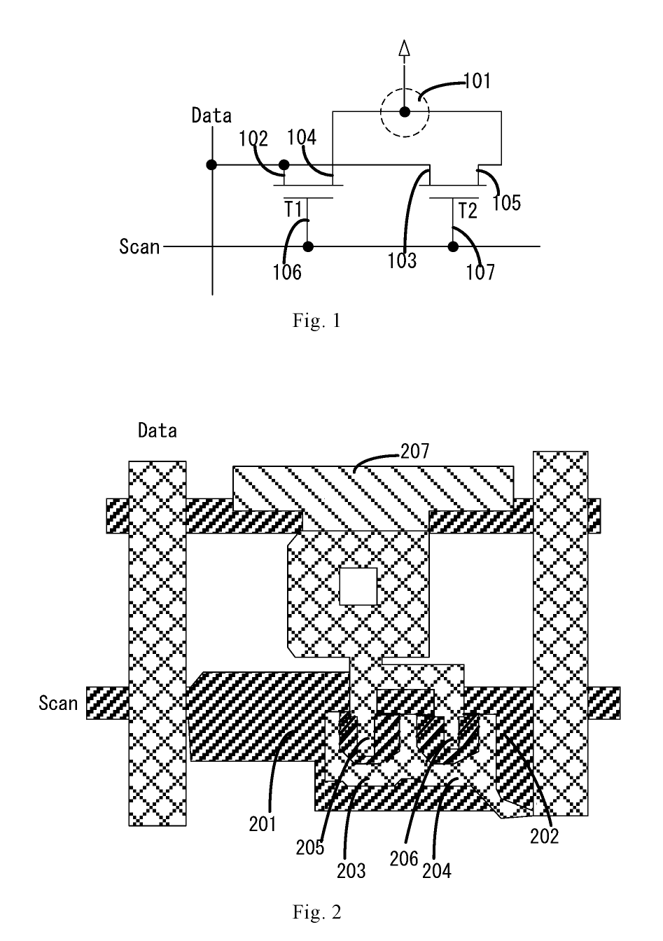

Please refer to FIG. 1 illustrating a schematic diagram of a pixel driving circuit according one embodiment of the present disclosure. The pixel driving circuit includes a data line Data, a scanning line Scan, a first pixel electrode 101, and two or more first switches T1 and T2. An input terminal 102 and 103 of each of the two or more first switches T1 and T2 is connected to the data line Data. An output terminal 104 and 105 of each of the two or more first switches T1 and T2 is connected to the same first pixel electrode 101. A control terminal 106 and 107 of each of the two or more first switches T1 and T2 is connected to the scanning line Scan. Accordingly, the first pixel electrode 101 can be charged at a faster speed.

To satisfy the growing desire of the audience for image fluency, the frame rate of image becomes greater and greater while the period of the pixel scanning signal becomes less and less. Besides, the scanning signal received by the pixel spends less and less time on driving the pixel, and it takes less and less time on charging the pixel electrode accordingly. However, it is inclined to charge the pixel electrode inadequately, which results in a decrease in the display quality of the display image and even fails to display images normally.

The number of first switches T1 and T2 connected to the first pixel electrode 101 is added to accelerate the charging of the first pixel electrode 101. Whenever the number of the first switches T1 and T2 increases, the first pixel electrode 101 is charged much faster. In this way, the charging shortage of the first pixel electrode 101 is well solved, which further facilitates adapt to the trend of the larger and larger frame rate of image display.

Different from the related art, in the present disclosure the input terminal 102 and 103 of each of the two or more first switches T1 and T2 is connected to the data line Data. The output terminal 104 and 105 of each of the two or more first switches T1 and T2 is connected to the same first pixel electrode 101. The control terminal 106 and 107 of each of the two or more first switches T1 and T2 is connected to the scanning line Scan. The two or more first switches T1 and T2 connected to the first pixel electrode 101 charge the first pixel electrode 101 after a scanning signal provided by the scanning line Scan is driven. Accordingly the charging of the first pixel electrode 101 will be accelerated, and the display quality of the display image will be improved.

The input terminal of each of the two or more first switches T1 and T2 is connected to the same data line Data. The control terminal of the two or more first switches T1 and T2 is connected to the same scanning line Scan. Accordingly, the two or more first switches T1 and T2 charge the first pixel electrode 101 at the same time to accelerate the charging of the first pixel electrode 101 to a large extent.

Optionally, each of the first switches is a TFT. A control terminal of the first switch is a gate of the TFT. An input terminal of the first switch is a source of the TFT. An output terminal of the first switch is a drain of the TFT. Surely, in another embodiment, an input terminal of a first switch is a drain of the TFT. An output terminal of the first switch is a source of the TFT. In another embodiment, a first switch may be an electronic component with a function of switch such as a complementary metal oxide semiconductor (CMOS).

Please refer to FIG. 2 illustrating a schematic diagram of a pixel driving circuit according the embodiment of the present disclosure. The gates of the two or more TFTs 201 and 202 and the scanning line Scan are arranged on the same layer. Each of the gates of the two or more TFTs 201 and 202 is connected to the scanning line Scan. The sources of the two or more TFTs 203 and 204 and the data line Data are arranged on the same layer. Each of the sources of the two or more TFTs 203 and 204 is connected to the data line Data. Each of the drains of the two or more TFTs 205 and 206 is connected to the first pixel electrode 207. The drains of the two or more TFTs 205 and 206 and the first pixel electrode 207 may or may not be arranged on the same layer. When the scanning signal transmitted through the scanning line Scan drives the two or more TFTs to operate, a data voltage transmitted through the data line charges the first pixel electrode 207 while passing through the two or more TFTs to accelerate the charging of the first pixel electrode 207.

Optionally, the TFT may is an amorphous silicon (a-Si) TFT. Surely, in another embodiment, amorphous indium gallium zinc oxide (IGZO) material may be substituted for amorphous silicon (a-Si) material.

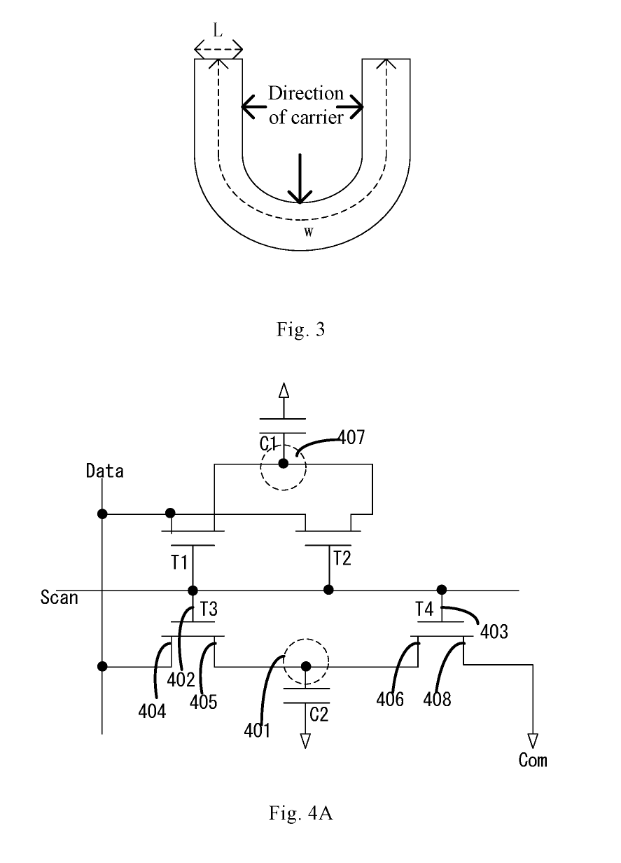

Please refer to FIG. 3 illustrating a schematic diagram of the structure of a conductive channel of the TFT illustrated in FIG. 2 according the embodiment of the present disclosure. The speed at which the a-Si TFT charges the first pixel electrode 101 is determined by the electron mobility μ of a charge carrier of the a-Si TFT to a large extent. The electron mobility μ is related to an aspect ratio W/L of the conductive channel of the TFT. The greater the aspect ratio W/L is, the greater the electron mobility μ is. As FIG. 3 illustrates, the arrangement of the two or more first switches and the first pixel electrode can broaden the width W of the conductive channel applied to the electron mobility μ. If the size of the conductive channel of each of the first switches is consistent, the sum of the electron mobility μ of the charge carrier of the N first switches is N*μ. The N first switches will charge the first pixel electrode at N times the speed of the standard condition.

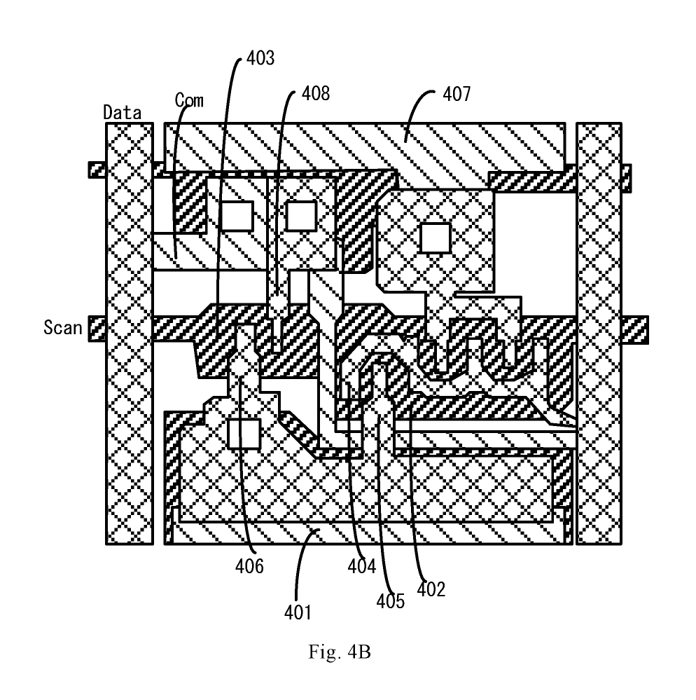

Please refer to FIG. 4A illustrating a schematic diagram of a pixel driving circuit and FIG. 4B illustrating a schematic diagram of the structure of the pixel driving circuit illustrated in FIG. 4A according to another embodiment of the present disclosure. The present embodiment further includes a second pixel electrode 401 and two or more second switches T3 and T4 based on the above-mentioned disclosure. A control terminal 402 and 403 of each of the two or more second switches T3 and T4 is connected to the scanning line Scan. An input terminal 404 of the second switch T3 is connected to the data line Data. An output terminal 405 of the second switch T3 is connected to the second pixel electrode 401, and an input terminal 406 of the second switch T4 is connected to the output terminal 405 of the second switch T3 to lower the pixel voltage of the second pixel electrode 401.

An input terminal 408 of the second switch T4 is connected to a common electrode Com.

To enlarge the viewing angle of the liquid crystal display, two different electrodes, such as the first pixel electrode 407 and the second pixel electrode 401, can be arranged in the same pixel. The first pixel electrode 407 will not be detailed since the above-mentioned embodiment has detailed the first pixel electrode. The second switch T3 provides the second pixel electrode 401 with power to provide a pixel electrode so that the first pixel electrode 407 and the second pixel electrode 401 can have different pixel electrodes. The second switch T4 is configured to lower the pixel electrode of the second pixel electrode 401 in the present embodiment. Specifically, when the second switch T4 is turned on, some output voltage imposed on the output terminal 405 of the second switch T3 (i.e., the pixel electrode of the second pixel electrode 401) is divided by the second switch T4 and then goes to the common electrode Com connected to an output terminal of the second switch T4. In this way, the pixel voltage imposed on the second pixel electrode 401 can be lowered successfully.

The first pixel electrode 407 and the second pixel electrode 401 provides a pixel electrode to a pixel together, and the first pixel electrode 407 is a primary pixel electrode of the pixel in this embodiment.

In another embodiment, a plurality of second pixel electrodes are adopted, and the plurality of second pixel electrodes have different pixel electrodes to further enlarge viewing angle of a liquid crystal display panel. In another embodiment, each of the plurality of second pixel electrodes further includes a first switch to accelerate a charging process.

Optionally, the present embodiment includes a first capacitor C1 and a second capacitor C2. The first capacitor C1 and the second capacitor C2 are connected to the first pixel electrode 407 and the second pixel electrode 401 correspondingly. The first capacitor C1 and the second capacitor C2 are configured to store a charging charge provided by the pixel driving circuit to the first pixel electrode 407 and the second pixel electrode 401 correspondingly so that the first pixel electrode 407 and the second pixel electrode 401 can be provided with a pixel voltage after the first switches T1 and T2 and the second switch T3 are turned off and before the first switches T1 and T2 and the second switch T3 are turned on again, and the pixel can work normally.

Optionally, the two or more second switches T3 and T4 are TFTs. The structure and working principle of the TFT is well detailed in the above-mentioned embodiments so the structure and working principle of the TFT will not be repeated.

Optionally, the frequency of the scanning signal provided by the scanning line is greater than 120 hertz (Hz); that is, the frame rate is greater than 120 Hz in the present embodiment. The frame rate greater than 120 Hz is generally defined as a high frame rate in the field of liquid crystal display. The application of driving display at high frame rates can satisfy the desire of the audience for image fluency.

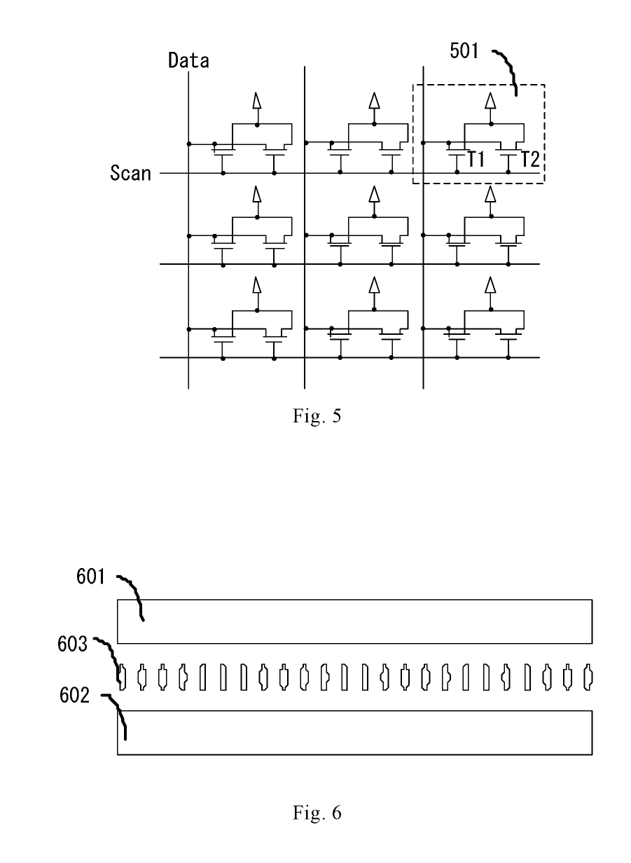

Please refer to FIG. 5 illustrating a schematic diagram of the structure of an array substrate according to another embodiment of the present disclosure. The present embodiment includes a plurality of pixel driving circuits 501 arranged in a matrix. The structure and working principle of the pixel driving circuit is well detailed in the above-mentioned embodiments so the structure and working principle of the pixel driving circuit 501 will not be repeated.

The plurality of pixel driving circuits 501 in the same column share the same data line Data. The plurality of pixel driving circuits 501 in the same row share the same scanning line Scan. Surely, in another embodiment, a plurality of pixel driving circuits 501 in the same row share the same data line Data. The plurality of pixel driving circuits 501 in the same column share the same scanning line Scan.

Compared with the related art, the pixel driving circuit 501 provided by the present disclosure utilizes the two or more first switches T1 and T2 to charge the first pixel electrode, not only the charging of the first pixel electrode is accelerated but also the display quality of the display image is improved.

Please refer to FIG. 6 illustrating a schematic diagram of the structure of a display panel according to another embodiment of the present disclosure. The display panel includes a first substrate 601, a second substrate 602, and a liquid crystal layer 603. The first substrate 601 and/or the second substrate 602 are/is array substrates as introduced in the above-mentioned embodiments. The liquid crystal layer 603 is arranged between the first substrate 601 and the second substrate 602 and is configured to adjust the transmittance of backlight light under control of the first substrate 601 and the second substrate 602.

The array substrate is well detailed in its structure, working principle, and process in the above-mentioned embodiments and can be referred to directly. The details of the array substrate will not be repeated.

Compared with the related art, the pixel driving circuit of the array substrate provided by the present disclosure utilizes the two or more first switches to charge the first pixel electrode, not only the charging of the first pixel electrode is accelerated but also the display quality of the display image is improved.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A pixel driving circuit, comprising:
a data line, a scanning line, a first pixel electrode, two or more first switches, a second pixel electrode, and two or more second switches;
wherein input terminals of the two or more first switches are connected to the data line; output terminals of the two or more first switches are connected to the first pixel electrode; control terminals of the two or more first switches are connected to the scanning line to accelerate charging of the first pixel electrode;
control terminals of the two or more second switches are connected to the scanning line;
an input terminal and an output terminal of one of the two or more second switches are connected to the data line and the second pixel electrode, respectively; an input terminal and an output terminal of the other one of the two or more second switches is connected to the output terminal of the one of the two or more second switches to lower pixel voltage of the second pixel electrode;
a frequency of a scanning signal provided by the scanning line is greater than 120 hertz (Hz).

2. The pixel driving circuit of claim 1, wherein the first pixel electrode and the second pixel electrode provide pixel voltage to the pixel; the first pixel electrode is a primary pixel electrode of the pixel.

3. The pixel driving circuit of claim 1 further comprising a first storage capacitor and a second storage capacitor, wherein the first capacitor and the second capacitor are connected to the first pixel electrode and the second pixel electrode correspondingly; the first capacitor and the second capacitor are configured to store charging charge provided by the pixel driving circuit to the first pixel electrode and the second pixel electrode correspondingly.

4. The pixel driving circuit of claim 1, wherein the first switch and the first switch both are thin film transistors (TFTs); the control terminal is a gate of the TFT; the input terminal is either a drain or a source of the TFT; the output terminal is the other of the drain and the source of the TFT.

5. The pixel driving circuit of claim 4, wherein the TFT is an amorphous silicon (a-Si) TFT.

6. The pixel driving circuit of claim 4, wherein a width/length (W/L) ratio of a channel of the TFT is adjusted to accelerate the charging of the first pixel electrode and the second pixel electrode.

7. An array substrate, comprising:
a plurality of pixel driving circuits arranged in an array; each of the plurality of pixel driving circuits comprising a data line, a scanning line, a first pixel electrode, and two or more first switches; wherein input terminals of the two or more first switches are connected to the data line; output terminals of the two or more first switches are connected to the first pixel electrode; control terminals of the two or more first switches are connected to the scanning line to accelerate charging of the first pixel electrode;
wherein the plurality of pixel driving circuits in the same column share the same data line, and the plurality of pixel driving circuits in the same row share the same scanning line; or the plurality of pixel driving circuits in the same row share the same data line, and the plurality of pixel driving circuits in the same column share the same scanning line.

8. The array substrate of the claim 7, wherein each pixel driving circuit further comprises a second pixel electrode and two or more second switches; control terminals of the two or more second switches are connected to the scanning line; an input terminal and an output terminal of one of the two or more second switches are connected to the data line and the second pixel electrode, respectively; an input terminal and an output terminal of the other one of the two or more second switches is connected to the output terminal of the one of the two or more second switches to lower pixel voltage of the second pixel electrode.

9. The array substrate of the claim 8, wherein the first pixel electrode and the second pixel electrode provide pixel voltage to the pixel, and the first pixel electrode is a primary pixel electrode of the pixel.

10. The array substrate of claim 8, wherein each pixel driving circuit further comprises a first storage capacitor and a second storage capacitor;
the first capacitor and the second capacitor are connected to the first pixel electrode and the second pixel electrode correspondingly; the first capacitor and the second capacitor are configured to store charging charge provided by the pixel driving circuit to the first pixel electrode and the second pixel electrode correspondingly.

11. The array substrate of claim 8, wherein the first switch and the first switch both are thin film transistors (TFTs); the control terminal is a gate of the TFT; the input terminal is either a drain or a source of the TFT; the output terminal is the other of the drain and the source of the TFT.

12. The array substrate of claim 11, wherein the TFT is an amorphous silicon (a-Si) TFT.

13. The array substrate of claim 11, wherein a width/length (W/L) ratio of a channel of the TFT is adjusted to accelerate the charging of the first pixel electrode and the second pixel electrode.

14. The array substrate of claim 7, wherein a frequency of a scanning signal provided by the scanning line is greater than 120 hertz (Hz).

15. A display panel comprising:
a first substrate, a second substrate, and a liquid crystal therebetween, wherein the first substrate or the second substrate is the array substrate as claimed in claim 7.

16. The display panel of the claim 15, wherein each pixel driving circuit further comprises a second pixel electrode and two or more second switches; control terminals of the two or more second switches are connected to the scanning line; an input terminal and an output terminal of one of the two or more second switches are connected to the data line and the second pixel electrode, respectively; an input terminal and an output terminal of the other one of the two or more second switches is connected to the output terminal of the one of the two or more second switches to lower pixel voltage of the second pixel electrode.

17. The display panel of the claim 16, wherein the first pixel electrode and the second pixel electrode provide pixel voltage to the pixel, and the first pixel electrode is a primary pixel electrode of the pixel.

18. The display panel of claim 16, wherein each pixel driving circuit further comprises a first storage capacitor and a second storage capacitor;
the first capacitor and the second capacitor are connected to the first pixel electrode and the second pixel electrode correspondingly; the first capacitor and the second capacitor are configured to store charging charge provided by the pixel driving circuit to the first pixel electrode and the second pixel electrode correspondingly.

19. The display panel of claim 16, wherein the first switch and the first switch both are thin film transistors (TFTs); the control terminal is a gate of the TFT; the input terminal is either a drain or a source of the TFT; the output terminal is the other of the drain and the source of the TFT.

20. The display panel of claim 19, wherein the TFT is an amorphous silicon (a-Si) TFT.
